(19) United States
(12) Patent Application Publication
(10) Pub. No.: US 2020/0253351 A1
(43) Pub. Date: Aug. 13, 2020

(54) HAIR STYLING TOOL AND METHOD OF USE

(71) Applicant: NASHARA FRAZIER, MIRAMAR, FL (US)

(72) Inventor: NASHARA FRAZIER, MIRAMAR, FL (US)

(21) Appl. No.: 16/359,320

(22) Filed: Mar. 20, 2019

Related U.S. Application Data
(60) Provisional application No. 62/646,488, filed on Mar. 22, 2018.

(51) Int. Cl. A45D 7/00; G09B 19/24; A45D 24/02; A46B 9/02; A46B 5/04

(52) U.S. Cl. CPC A45D 7/00; G09B 19/24; A45D 24/02; A46B 2200/104; A46B 5/04; A45D 2200/25; A45D 2007/004; A46B 9/023

(57) ABSTRACT

A hair styling finger tool that includes a flexible body formed in the shape of a human finger, wherein the body comprises a surface, and a plurality of hair guiding features disposed on the surface of the body. A method of styling hair is disclosed, including providing a hair styling finger tool for use on a finger, wherein the hair styling finger tool includes a flexible body formed in the shape of a human finger, wherein the body comprises a surface, and a plurality of hair guiding features disposed on the surface of the body, and using the hair styling finger tool to perform a hair styling method with a finger.

### PRIORITY CLAIM

This application is a non-provisional application of, and hereby claims priority under 35 U.S.C. § 119 to, U.S. provisional patent application No. 62/646,488, titled “Hair Styling Finger Tool And Method Of Use,” by inventor Nashara Frazier, which was filed on Mar. 22, 2018, and which is incorporated by reference.

### FIELD

The following disclosure relates generally to human hair styling tools, and methods for using human hair styling tools to style hair, and more specifically, to hair styling tools designed to be worn on one or more fingers while leaving the rest of a user's hands uncovered, and which are particularly suitable for use on naturally spirally curly hair and/or naturally organized spirally curly hair, and related methods of use thereof.

### BACKGROUND

Humans have been styling hair for millennia. The styling of hair may be considered an aspect of personal grooming, cosmetics, fashion, self-expression, and/or gender, cultural, or religious identity. The styling of hair has usually involved a person using their bare hands to manipulate their hair, such as by braiding their hair. People have also used styling tools, such as brushes, combs, curling irons, blow dryers, scissors, clippers, razors, and the like, to style their hair. Such tools are gripped by a person using their entire hands, usually a person styling their own hair, or a hairdresser or barber styling the hair of another. In more recent history, persons have applied chemicals to their hair to achieve certain styles, such as hair colorings, conditioners, lotions, oils, bleaches, and hair perming chemicals, such as ammonium thioglycolate, which works by breaking down the disulphide bonds in the hair follicle. Perming chemicals soften and swell the hair's keratin, allowing the hair to be manipulated into the desired style.

The problem with using bare hands to style hair is that it is not an effective aid for detangling; provides low retention for curl formation; provides only one type of surface to manipulate hair, namely a person's skin; can be painful for persons with sensitive skin due to the friction caused by hair, heat, and chemicals, or finger nails too sensitive or short to separate hair.

While existing tools have solved some of these problems, such as more effective detangling by brushes, they present their own set of problems including: being inflexible, providing only temporary style retention (in the case of brushes and combs), being obstructive and bulky, and being inefficient, causing users to have pick-up and lay down the tools every time they perform a styling method and prevent users from using the full dexterity of their hands.

For example, once a user has completed a step of detangling using a brush or comb, the user would typically rest the brush or comb and continue with styling. During styling with one's bare hand however, hair can become tangled again requiring the user to have to stop the process to pick up the brush or comb and detangle the hair once again. Some users will also use bare hands to separate hair creating a part. The resulting part is usually not uniform or in a straight line.

Yet another issue with using only hands or existing tools to style hair, is that they cause the time it takes to complete a hair style very long relative to the invention disclosed herein. For example, some of the hair styling methods disclosed herein can take upwards of several hours, or 25% to 50% longer to complete with only hands and/or existing tools.

### BRIEF SUMMARY

The various embodiments disclosed herein result from the realization that the styling of hair may be achieved more quickly, efficiently, and effectively by providing the hair styling finger tool and method of use thereof, as described herein and shown in the drawings. This tool and related method of use provides the following results, and more, when compared to existing hair styling tools: reduces the amount of time to complete a hairstyle by 25% to 50%, provides for longer style retention in the hair, meaning that hairstyles last longer, and user fatigue is reduced since users no longer have to lay down and pick-up tools as they style hair.

### BRIEF DESCRIPTION OF THE DRAWINGS

FIGS. 1A-1L each shows a hair styling finger tool in accordance with one or more embodiments.

FIGS. 1M-1P each shows a cross-section of a hair styling finger tool in accordance with one or more embodiments.

FIG. 2 shows a hair styling finger tool in accordance with one embodiment.

FIG. 3 shows a hair styling finger tool in accordance with another embodiment.

FIGS. 4A and 4B show a hair styling finger tool in accordance with yet another embodiment.

FIG. 5 shows a hair styling finger tool (s) in accordance with one or more embodiments.

FIG. 6 shows exemplary length designations illustrated on a hand and finger.

FIGS. 7A and 7B are diagrams depicting various hand and finger measurements.

FIG. 8 shows a method for using a hair styling finger tool in accordance with one embodiment.

FIGS. 9A-9F each shows the result of a method for using a hair styling finger tool in accordance with one or more embodiments.

FIGS. 10A-10Z each shows a hair styling tool in accordance with one or more embodiments.

FIGS. 11A-11M each shows a hair styling tool in accordance with one or more embodiments.

FIGS. 12A-12K each show a combination hair styling tool in accordance with one or more embodiments.

### DETAILED DESCRIPTION

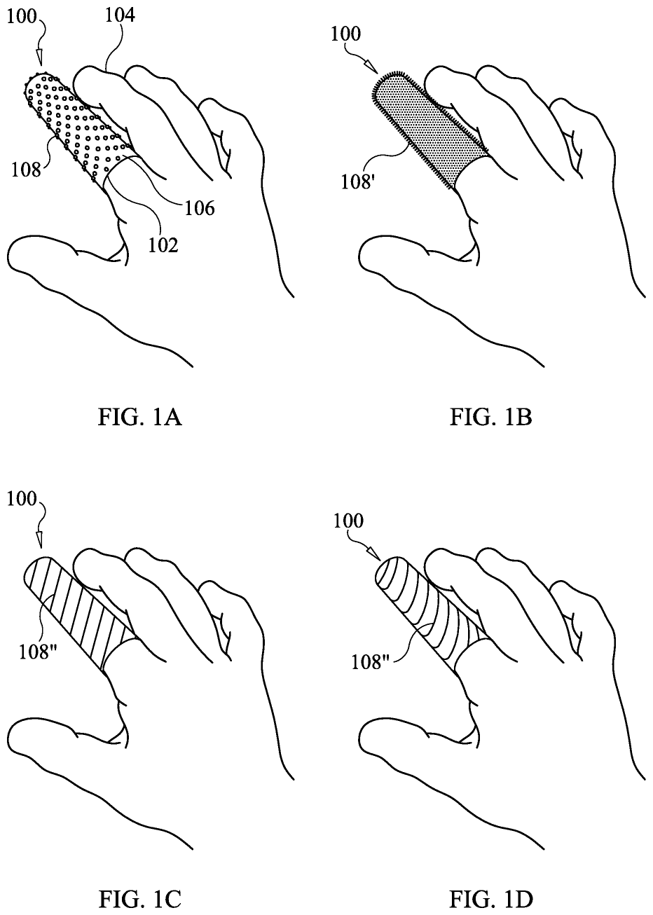

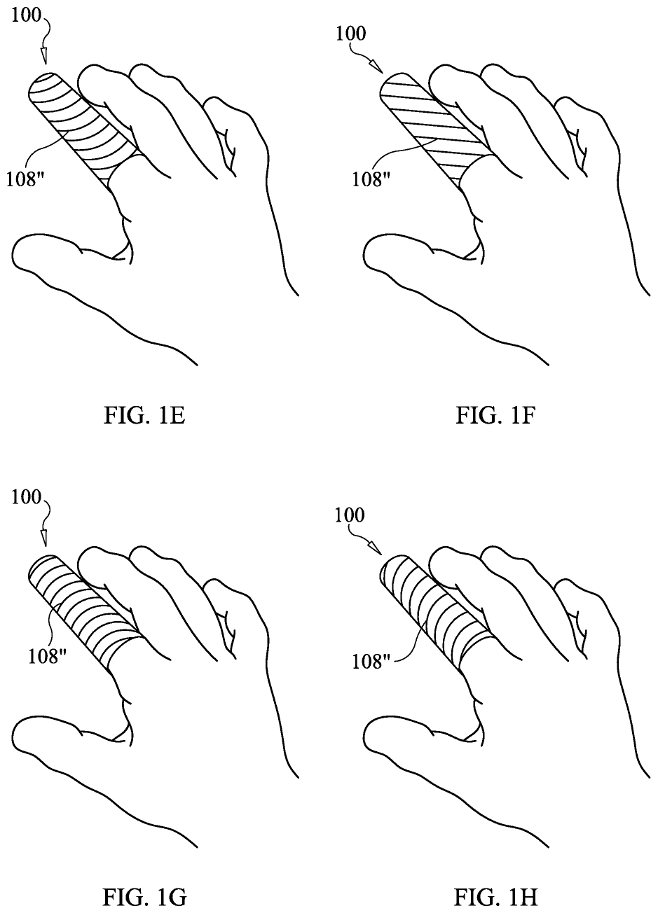

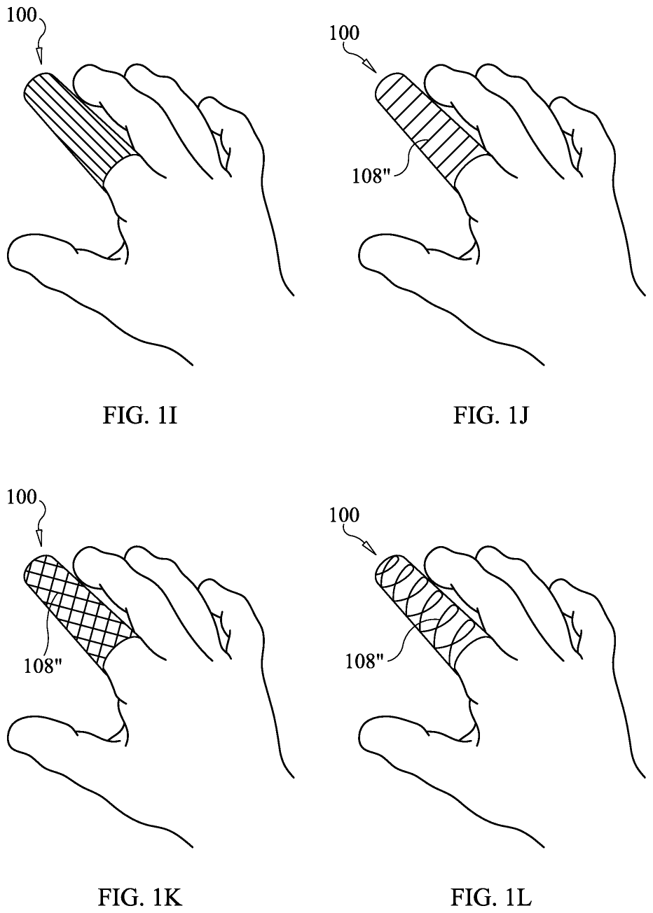

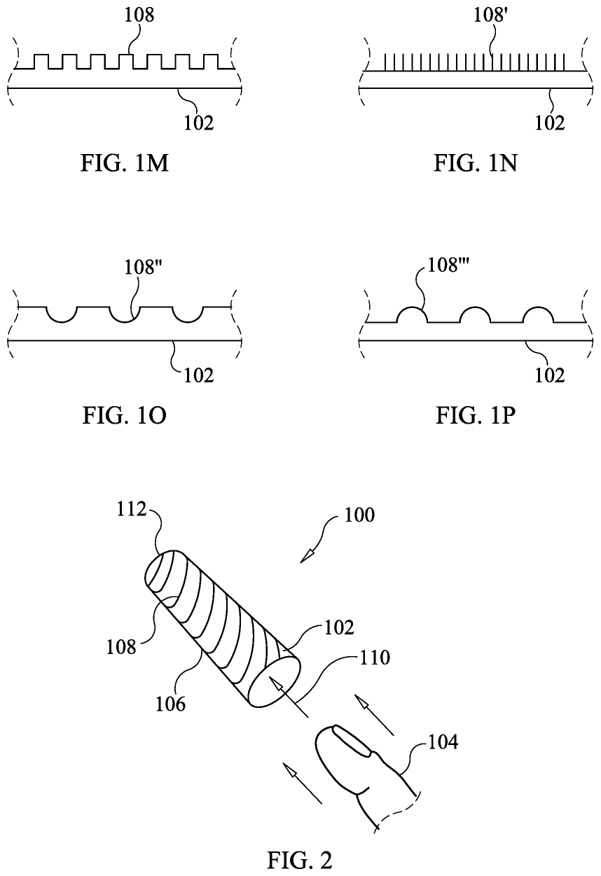

Referring now to the drawings, FIGS. 1A through 1L, a hair styling finger tool 100 is shown in accordance with various embodiments. Tool 100 may comprise a flexible body 102 formed in the shape of a human finger (shown exemplarily as 104), wherein body 102 comprises a surface 106, and a plurality of hair guiding features 108 disposed on surface 106.

In some embodiments, the features 108 may comprise a variety of types of features, such as, but not limited to, studs 108 (shown in FIG. 1A), bristles 108′ (shown in FIG. 1B), grooves 108″ (shown in FIGS. 1C-1L), and or smooth (not shown). Features 108 may be distributed evenly or uniformly over the entirety of surface 106 (as shown in the drawings), or may be limited to certain portions of surface 106′s area. Having the features 108 be distributed uniformly over the entirety of surface 106 provides the added benefit of a more usable surface area. In other embodiments, part of surface 106 is covered in one type of feature 108, and other part(s) of surface 106 may be covered in other type(s) of features. This provides the added benefit of allowing a user to use tool 100 to perform different styling methods with one tool.

In some embodiments, tool 100 may be sized specifically for certain types of fingers, such as thumb, index finger, middle finger, ring finger, and/or pinky. The sizing may be based on averages of human fingers, and may be termed “small,” “medium,” “large,” and the like, and may be based on gender, depending on where the sizing of a tool 100 falls on the range of human finger average sizes (from the smallest to largest).

In some embodiments, grooves 108″ may be straight or curved, and arching or proceeding in different directions, as shown in FIGS. 1C-1L. Grooves 108″ may be substantially parallel to each other, as shown in FIGS. 1C-1J, or may intersect with each other, as shown in FIGS. 1K and 1L. In some embodiments grooves 108″ may comprise one or more grooves, such as, but not limited to, grooves formed in a spiral or corkscrew extending along a length of body 102. As used herein, the “length” of the body 102 refers to the length taken from an open end of body 102 through which the finger 104 is inserted to the opposite end, which can be a closed end, usually positioned where the end of finger 104 and a fingernail resides while positioned inside tool 100. In yet another embodiment, grooves 108″ may comprise inverted grooves, such as ridges 108′″, as shown in FIG. 1P.

Cross-section views of body 102 and the various embodiments of features 108 are shown in FIGS. 1M through 1P.

In another embodiment, tool 100, body 102, and/or features 108 are formed of rubber. In yet another embodiment, tool 100, body 102, and/or features 108 are formed of another substance or material having a dynamic surface-to-hair coefficient of friction in the range of 0.15 through 0.75. Having dynamic friction between tool 100, body 102, and/or features 108 is advantageous because the friction between these components and hair moving along them helps impart styling to the hair, such as by helping form coils or curls, or inducing coils or curls to form, or straightening the hair.

In yet another embodiment, body 102 may comprise a unitary body, meaning that the body 102 and features 106 are formed of unitary substance or material. This may make manufacturing of tool 100 easier, since methods such as molding, including injection molding, may be used.

Referring now to FIG. 2, in some embodiments body 102 may comprise an open end 110 configured to receive finger 104, and a closed end 112. In some embodiments, closed end 112 may comprise a rounded, or uniformly rounded end (as shown in FIG. 2). In yet other embodiments, closed end 112 may comprise a rigid point 114, as shown in FIGS. 4A (top view) and 4B (side view). Rigid point 114 may be formed as the same flexible material as body 102, but with a greater thickness so as to be less flexible and more rigid than body 102. In another embodiment, rigid point 114 may be formed of a different, more rigid material than body 102, and may be affixed to body 102, such as by gluing, melting, or other form of bonding. For example, rigid point 114 may be formed of plastic, metal, wood, polyvinyl chloride, ceramic, glass, sapphire, bone, and the like. In some embodiments, the dynamic coefficient of friction between point 114 and hair should be less than the coefficient of friction between the rest of tool 100, body 102, and/or features 108, and preferably, as low as possible.

In yet another embodiment, rigid point 114 may be formed in the shape of a long fingernail, so as to present a shape that a user is similar to dealing with, which provides the added benefit of a shorter learning curve for learning how to use tool 100.

Rigid point 114 may comprise a hair separator, which may be used to separate hair strands, or groups of hair strands, and/or create parts in a person's hair.

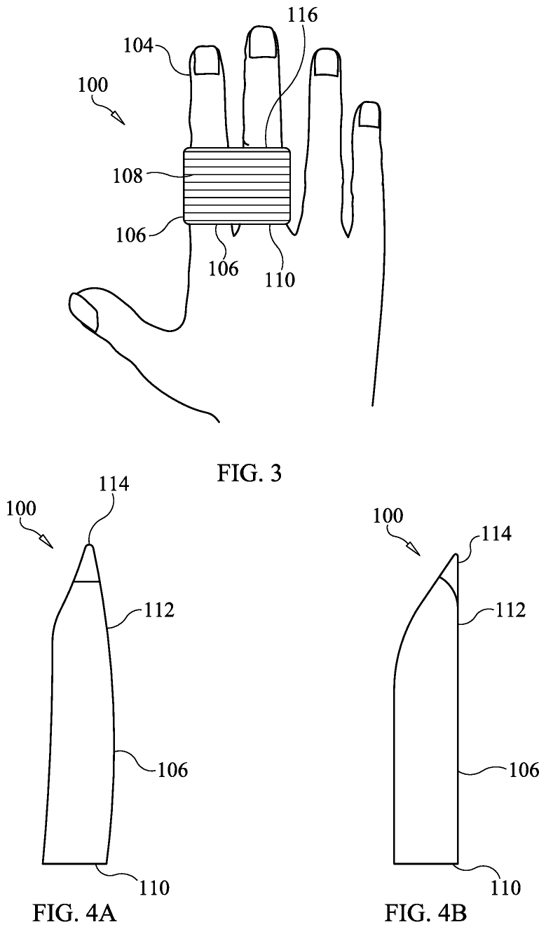

Referring now to FIG. 3, tool 100 is shown in accordance with yet another embodiment, wherein tool 100 comprises two open ends 110, 116, such that one or more fingers 104 may be slipped through tool 100. In a preferred embodiment, tool 100 may be in the shape of a sleeve or band that is slide over two of a users' fingers 104, which provides improved “MCT” (defined below) effects when styling hair.

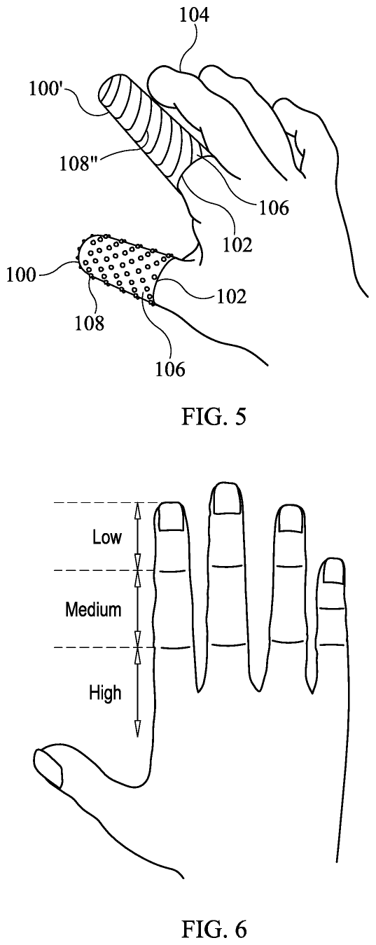

FIG. 5 shows an embodiment wherein two tools 100, 100′ are simultaneously used by a user to style hair. In one embodiment, one tool 100 may be used on a user's index finger, while another tool 100′ may be used on the user's thumb. Such an arrangement is preferred for multi-tool use, because a user would be able to use their primary ‘tool’ fingers, namely index finger and thumb, to style hair using tools 100, 100′, leaving their remaining fingers and hand to manipulate the hair, use other tools or objects, and/or use their bare skin and touch to feel the hair and its texture, and the like.

In one embodiment, a hair styling finger tool kit comprising a plurality of hair styling finger tools 100, 100′, wherein each of the plurality of hair styling finger tools 100, 100′ comprises a flexible body 102 formed in the shape of a human finger 104, wherein the body 102 comprises a surface 106, and a plurality of hair guiding features 108, 108′, and 108″, disposed on the surface 106 of the body 102, wherein the hair guiding features 108, 108′, 108″, on a first of the plurality of hair styling finger tools 100, 100′ comprises a plurality of studs 108, wherein the hair guiding features on a second of the plurality of hair styling finger tools comprises a plurality of bristles 108′, wherein the hair guiding features on a third of the plurality of hair styling finger tools 100 comprises a plurality of grooves 108″, and at least one of the plurality of hair styling finger tools comprises an open end 110 and a closed end 112, wherein the closed end 112 comprises a rigid point 114 or a uniformly rounded end. In some embodiments, the kit may comprise a tool 100 having two open ends 110 and 116, as shown in FIG. 3. In yet another embodiment, the kit further comprises a set of instructions for how to use at least one of the plurality of hair styling finger tools 100, 100′ to style hair, according to one or more of the methods disclosed herein. Such instructions may be written and include pictures showing the styling methods and/or steps of each method. The instructions may also be provided on a computer readable medium, such as a CD or DVD, and may include audio and/or video instructions. The instructions may be provided via a downloadable computer file, a link to which may be provided in the kit.

Each of the various types of surface features 108, 108′, 108″ provides a certain type of hair styling, and depending on the type of hair style desired by a user, such user can select the most beneficial feature type to aid in styling. For example, the groove type feature 108″ can provide guided (e.g. corkscrew-like) indentations to lead the hair around the user's finger to create a smoother or larger curl or coil. The bristle type feature 108′ can be used to detangle or straighten hair. And, the stud type feature 108 can be used to impart curls or coils that are tighter than those formed by the groove feature 108″.

While additional surface feature types may be provided on body 102, the types of types of features disclosed herein are preferable due to the particularly advantageous hair styling properties they possess, including providing the following results, and more, when compared to existing hair styling tools: reduces the amount of time to complete a hairstyle by 25% to 50%, provides for longer style retention in the hair, meaning that hairstyles last longer, and user fatigue is reduced since users no longer have to lay down and pick-up tools as they style hair.

For example, once a user has completed a step of detangling using a brush or comb, the user would typically rest the brush or comb and continue with styling. During styling with one's bare hand however, hair can become tangled again requiring the user to have to stop the process to pick up the brush or comb and detangle the hair once again. By using tool 100, the user can use features 108, 108′, 108″ to smooth hair to remove tangles while styling hair, thereby reducing the need to continually stop the styling process, pick up a comb or brush, detangle hair, replace the comb or brush to rest. Accordingly, tool 100 will not only reduce the effort and energy expended styling hair, but will also reduce time spent on the entire styling process, particularly the detangling process.

Using tool 100 can also aid in creating consistently clean and straight part lines without the need of using a separate brush or comb. Accordingly, less styling tools are needed and less time is used on this step during the styling process.

Further, even nowadays users primary rely on using bare hands to perform these types of styling steps. While a bare hand may serve as a curling tool (e.g. during coiling), human skin does not provide any guided, detangling textures since it is effectively a smooth surface. Further, as explained above, many users use hair care, curling, conditioner, and hold-hair chemical products to style hair that get adsorbed into the users skin causing it to become irritated and pruned. Excessive time in water or covered in hair styling products, can cause the user's skin to become dehydrated or overly hydrated. Preventing your fingers from becoming excessively hydrated or dehydrated is desired especially if the user has sensitive skin. Tool 100 can help to reduce the user's contact with moisture and heat from hair styling products and tools.

There are numerous types of hair, ranging from thick and curly to thin and straight. The various types of hair can generally be classified into a scale of twelve types: 1A, 1B, 1C, 2A, 2B, 2C, 3A, 3B, 3C, 4A, 4B, and 4C. Tool 100 and the methods disclosed herein may be applied to any type of hair texture, however, they are primarily effective for hair types 3A-3B (curly) and types 4A-4B (coily). The sub classifications—from A to C—are based upon the density and diameter of the wave, curl or coil pattern (A being least dense or thick, and C being most dense or thick). A person's hair can have multiple hair textures ranging from hair types 1A-1C (straight) through types 4A-4C (coily). While the tools and methods disclosed herein are for spirally curly hair, organized spirally curly hair, wavy to naturally spirally, and/or tightly coiled to zig zag patterned hair, they may be used for any type of hair texture.

Body 102 may be formed of a material having a thickness (and thus the body may have a thickness) in the range of 0.25 mm through 2.5 mm, with a preferred thickness in the range of 1.0 mm through 2.0 mm, which provides an optimal level of flexibility in the material, while maintaining the necessary rigidity required to impart the coefficient of friction properties against hair as discussed herein.

In some embodiments, body 102 may be 1 to 4 inches in length (for embodiments without rigid point 114), and a preferred range of 2 to 3 inches (again, for embodiments without rigid point 114). Embodiments with rigid point 114 may add an additional 0.25 to 1 inch to this range.

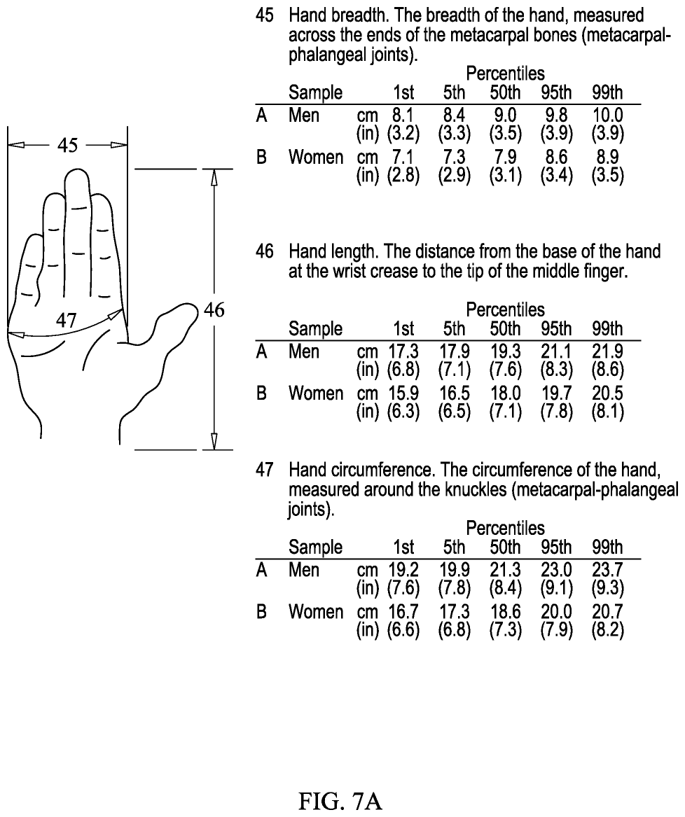

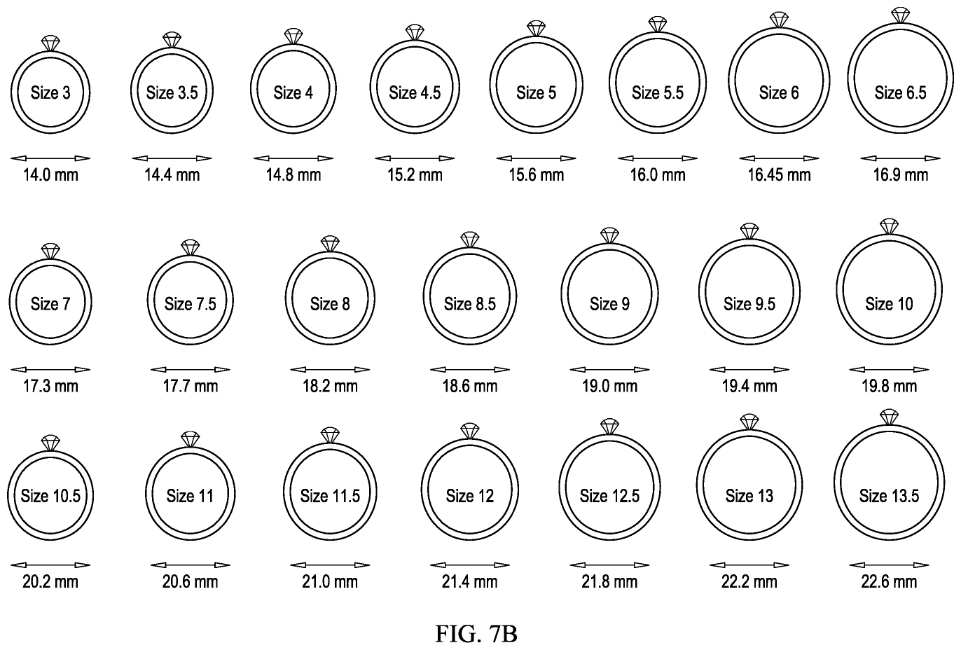

Referring now to FIGS. 6, 7A, and 7B the length of body 102 may also be described in terms of “low,” “medium,” and “high” lengths, with “low” meaning from tip of finger to first joint (knuckle), “medium” meaning from tip of finger to second joint (knuckle), and “high” meaning from tip of finger to third, final joint (knuckle). In some embodiments, the thickness of material from which body 102 is formed may decrease as the length increases. Thus, a low version of body 102 may have a greater thickness than medium and high versions of body 102, and a high version of body 102 may have a smaller thickness than medium and low versions, with a medium version of body 102 having a thickness less than the low version's thickness, and greater than the high version's thickness.

Referring now to FIGS. 7A and 7B body 102 may be formed of a stretchable or flexible material in order to fit snuggly on a range of finger sizes. Preferred sizing will be for small, medium and large finger diameters and circumferences. For example, a medium ring size in the United States is 6-8 (average U.S. ring size is 7).

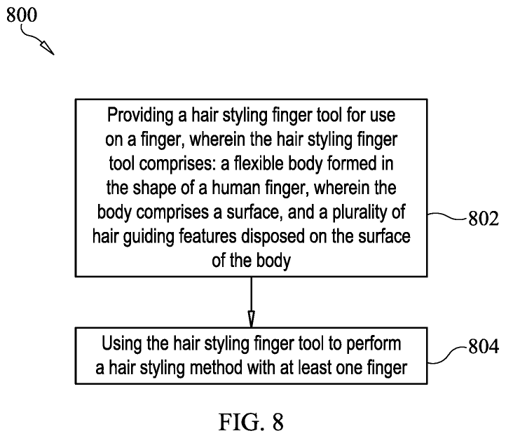

With reference now to FIG. 8, a method 800 for using tool 100 to style hair is shown in accordance with various embodiments.

In one embodiment, a general styling method 800 may comprise providing one or more tools 100 on one or more fingers 104, and sliding tool(s) 100 along hair. Tool 100 may be placed on a primary finger, such as the index finger, for producing coiling and/or curling effects in the hair via the friction produced by the tool 100, and by the hair guiding features 108, 108′, and 108″ guiding the hair during the sliding action. Slight load may be placed against the hair to impart greater friction, and, accordingly, tighter curls. The higher the load that is applied to the hair via tool 100, the tighter the curls, and styling effect generally. In another embodiment, additional tools 100 may be positioned on the middle finger and/or thumb of the same hand as the tool 100 on the index finger, to provide additional curling and/or coiling effects with the hair being pinched between tools 100.

As described below, tools 100 may be positioned on index and thumb fingers of the same hand may be used for MCT (defined below) methods, with optionally providing tools 100 on the middle finger, or using an optional multi-finger (e.g. 2 or 3 finger) pad or band, as shown in FIG. 3.

In yet another embodiment, both index fingers of both hands may be fitted with tools 100 for performing braiding methods, such as French braiding. In yet a further embodiment, both index fingers and thumbs (on both hands) may be fitted with tools 100 for performing hair twisting actions, with preferably at least one tool being fitted with rigid point 114 for separation hair. A user may add hair product, such as one or more of the chemicals described herein as needed prior to or post portioning or separating hair.

Referring again to FIG. 8, a method 800 for styling hair is disclosed. Traditional hair styling (“styling,” as used herein, refers to the shaping of hair, as opposed to coloring) methods can easily take over three hours to complete (depending on length of hair), however method 800, which employs tool(s) 100 can reduce the amount of time it would otherwise take to coil or curl hair by 25% to 50%. Further, method 800, which employs tool(s) 100 results in more uniform curls, and rigid point 114, if present, may be used help separate the curls or clusters of curls to get more curls, and provides for less frizz. Method 800 may be performed by providing one or more tool(s) on thumb, index and middle fingers of one or both hands, depending on if a user wishes to have a free hand without tools 100 to manipulate the hair and/or other tools. Tools 100 may also comprise rigid point 114. Tools 100 may comprise one or more of the various features 108 disclosed herein depending on any additional styling effects the user wishes to impart on the hair.

In some embodiments, method 800 comprises a method of styling hair, comprising providing a hair styling finger tool 100 for use on a finger 104, wherein the hair styling finger tool 100 comprises: a flexible body 102 formed in the shape of a human finger 104, wherein the body comprises a surface 106, and a plurality of hair guiding features 108, 108′, 108″ disposed on the surface 106 of the body 102 (collectively, step 802); and using the hair styling finger tool 100 to perform a hair styling method with at least one finger 104 (step 804).

In some embodiments, styling method 800 may comprise a coiling or curling method, which may comprise starting with clean hair, washed and conditioned, which is still damp or wet. Coiling or curling may also include, using tool 100 and/or point 114 to part hair into small rows or sections and clip the rest out of the way. Coiling or curling may also comprise using tool 100 to detangle the hair prior to coiling or curling. Optionally, a user may apply desired moisture and hold base (e.g.. leave-in conditioner; curl cream; gel; and the like) prior to separating hair, which may improve the coil or curl inducing properties of tool 100 since the base may enable the hair to be guided more easily by the tool, and the base may enable the hair to cluster in the desired shape (e.g. coil or curl) more effectively since the base causes individual hair strands to stick to each other and form coiled or curled clusters more effectively.

Coiling or curling method may also comprise using point 114 of finger tool 100 (or simply a closed end of finger tool 100 for tools without rigid point 114) to section a piece of hair to create individual coils by dragging the sectioned hair against tool 100 (or dragged and pinched between two tools 100). Smaller sections of hair result in smaller coils, and larger sections for larger coils (using only the index finger tool 100 or index and middle finger tools 100 to pinch).

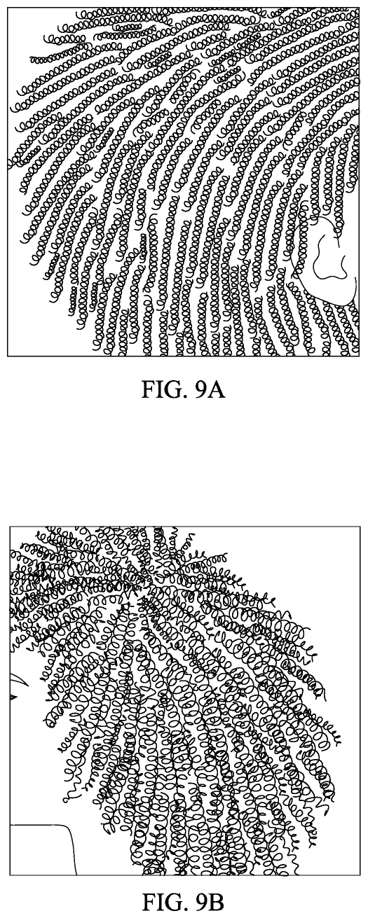

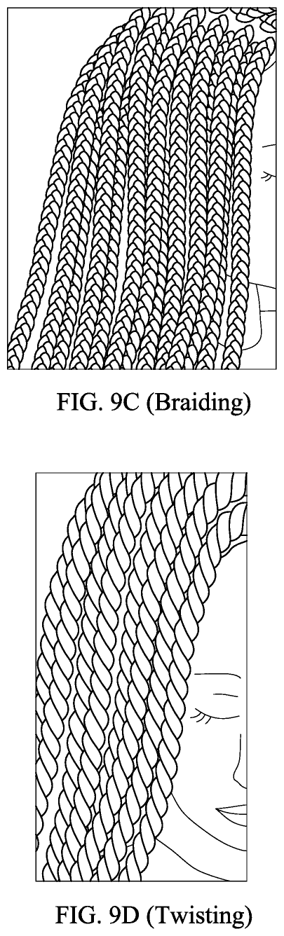

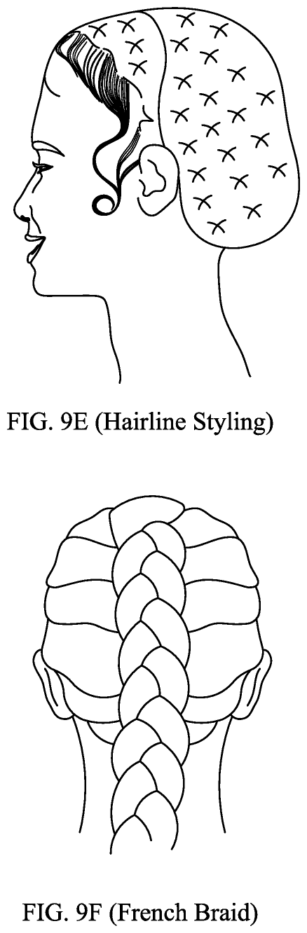

In a preferable embodiment, coiling or curling is done from the scalp outwardly, holding in between the thumb (which may be optionally and preferably fitted with tool 100) and index finger tool 100, and stretching and twirling the section of hair repeatedly moving tool(s) 100 down the hair until at the end of the hair creating the desired coil or curl. A user may use tool(s) 100 to stretch and twirl more for a tighter curl. Repeat until all of the hair is completely curled or coiled, or the portion of hair desired to be coiled or curled is completely coiled or curled. As a final optional step, user may seal hair using an oil or balm of user's choice, and dry the hair using a desired drying method (e.g. blow dry, air dry, and the like). Without tool 100, the coiling or curling method could easily take over three hours to complete. However, tool 100 cuts down on this amount by 25% through 50%. An example of the results of the coiling or curling method is shown in FIG. 9A.

In another embodiment, method 800 may comprise performing a multistrand clustered texturing (“MCT”) method. The MCT method may also be referred to as “shingling,” wherein small clusters of curled or coiled hair are formed in an intentionally less organized form (or if the hair is naturally curly or coily in a less organized form, then allowing the hair to retain its natural form) than the standard or intentionally more organized curling or coiling method, for example, such as the curling/coiling method disclosed above. When performing the MCT method, the following tool 100 arrangement options may be used: (1) thumb finger tool and/or index finger tool(s) 100 (with optional point 114 on each or both finger tools); (2) thumb with point 114 and middle finger tool 100; (3) thumb finger with finger tool 100 and two finger pad or band embodiment tool 100 (shown in FIG. 3) or (4) thumb finger with finger tool 100 and three finger pad or band type tool 100; or (5) any one or more of (1)-(4) wherein each tool 100 comprises one or more of the plurality of types of surface features 108 disclosed herein.

As it applies to the MCT method, the resistant/frictional nature of surface 106 of tool 100 serves to reduce the number of times a user must pass their hand to perform the MCT method. The resistance/friction induces the curls. “Shingling,” as used herein, means the act of using tool(s) 100 to simultaneously curl and separate hair into clustered curls resulting in smaller and less organized clusters of curls than standard coiling or curling. If tool(s) 100 are applied to two (2) fingers that pinch the hair, then smaller clusters featuring shorter and tighter textured clusters having more retention are formed. If multiple fingers with tool(s) 100 are used on the same side (vs. opposite sides, such as when two fingers pinch hair) of the hair when stroking or passing on the hair, then longer and bigger textured clusters are formed. If a ‘prayer hands’ method is used, wherein the user sandwiches their hair between their hands, including palms and fingers (with or without tool(s) 100), in a stroking motion, then the same result is achieved as using tool(s) 100 on the same side with a stroking motion. Therefore, an advantage of having tool(s) 100 fitted to finger(s) on the same side is that the same result as traditionally using prayer hands is achieved, yet the user's other hand and other fingers are free to perform other tasks and/or remain free of contamination by the base product if it has been applied.

In some embodiments, the MCT method may comprise starting with clean hair, washed and conditioned, which is still damp or wet. The MCT method may also include using tool 100 and/or point 114 to part hair into small rows or sections and clip the rest out of the way. The MCT method may also comprise using tool 100 to detangle the hair prior (described below) to coiling or curling. Optionally, a user may apply desired moisture and hold base (e.g.. leave-in conditioner; curl cream; gel; and the like) prior to separating hair, which may improve the coil or curl inducing properties of tool 100 since the base may enable the hair to be guided more easily by the tool, and the base may enable the hair to cluster in the desired shape (e.g. coil or curl) more effectively since the base causes individual hair strands to stick to each other and form coiled or curled clusters more effectively.

Once the hair is substantially tangle-free and separated, tool 100 (and preferably rigid point 114) may be used to section a piece of one or more hairs, wherein for finer or smaller clusters a smaller section of hair may be sectioned off, or for larger clusters, larger sections of hair may be sectioned off.

Shingling may also comprise using a tool 100 having a surface feature 108″ (e.g. grooved) applied to a thumb and index finger, or thumb, index and middle fingers, or thumb and a finger-pad type tool 100 (see FIG. 3) applied to one or more fingers, capture the sectioned off hair between the tools 100, and preferably between thumb and index finger, or thumb and middle finger, tools 100 of the same hand, and move the tools 100 in a smooth outward or downward motion away from the scalp. In a further embodiment, shingling may comprise separating or dividing the hair into smaller parts thereafter, and pulling or dragging the tools 100 along the divided hair away from the scalp and away from larger sections of the hair. This forms finer, frizzier, or more random or less organized clusters. If they started with smaller pieces of hair, finer and tighter clusters are formed. A user may wish to perform this additional and optional step if they wish to form even finer and tighter clusters than obtained when initially performing the preceding method steps.

In the final step of forming a MCT cluster, a user would use tools 100 fit to thumb and index fingers of the same hand to hold or pinch the divided off section of hair between the tools 100, and stretch the section of hair repeatedly moving along the section of hair in a direction away from the scalp until the end of the hair, thereby creating the desired MCT cluster.

To complete the entire MCT process, the foregoing MCT steps may be repeated for the remaining portions (or all) of the hair desired to be MCT clustered or shingled. As a final optional step, user may seal hair using an oil or balm of user's choice, and dry the hair using a desired drying method (e.g. blow dry, air dry, and the like). Without tool 100, the MCT method could easily take over an hour to complete. However, tool 100 cuts down on this amount by 25% through 50%. An example of the results of the MCT method is shown in FIG. 9B

In another embodiment, method 800 may comprise performing a braiding method. When performing the braiding method, the following tool 100 arrangement options may be used: (1) tools 100 fit to thumbs, index and middle fingers of both a user's hands (two sets of tools, one for each hand); with preferably (but optionally) rigid point 114 on any or all (preferably at least more than one) of the foregoing tools 100; and/or wherein each tool 100 comprises one or more of the plurality of types of surface features 108 disclosed herein.

As it applies to the braiding method, the resistant/frictional nature of surface 106 of tool 100 serves to allow a user to grip and manipulate the hair more easily, and point 114 allows the user to separate the hair more easily for braiding purposes. “Braiding,” as used herein, means the act of using tool(s) 100 to braid hair in to various forms of braids, such as flat braids, twist-out braids, French braids (shown in FIG. 9F), and the like.

In some embodiments, the braiding method may comprise using tool 100 (preferably with a bristle 108′ surface feature) to smooth out any knots or tangles in the hair. Then, using tool(s) 100 (preferably tools 100 fitted to thumb, index, and middle fingers on both hands) and/or point(s) 114, part hair into sections clip the rest out of the way. Thereafter, using tool(s) 100, take a desired section of hair for the braid, gather at the top of the hair (near the scalp) and divide into a number of sections or sub-sections based on the style of braid desired (e.g. three sections). Then, using tool(s) 100, crossing the sections of hair overlapping each piece. While braiding, a user may use tool(s) 100 to add hair to a particular section using tool 100 and/or point 114, and add hair to other sections or non-sectioned-off portions of hair.

In the final step of forming a braid, a user would secure the braid at its end away from the scalp with a band, roller, coil, clip, or other hair-affixing tool. As a final optional step, user may seal hair using an oil or balm of user's choice, and dry the hair using a desired drying method (e.g. blow dry, air dry, and the like). Without tool 100, the braiding method could easily take over an hour to complete. However, tool 100 cuts down on this amount by 25% through 50%. An example of the results of the braiding method is shown in FIG. 9C, and FIG. 9F (French braid).

In yet another embodiment, method 800 may comprise performing a twisting method.

When performing the twisting method, the following tool 100 arrangement options may be used: (1) tools 100 fit to thumbs, index and middle fingers of both a user's hands (two sets of tools, one for each hand); with preferably (but optionally) rigid point 114 on any or all (preferably at least more than one) of the foregoing tools 100; and/or wherein each tool 100 comprises one or more of the plurality of types of surface features 108 disclosed herein.

As it applies to the twisting method, the resistant/frictional nature of surface 106 of tool 100 serves to allow a user to grip and manipulate the hair more easily, and point 114 allows the user to separate the hair more easily for twisting purposes. “Twisting,” as used herein, means the act of using tool(s) 100 to twist hair in to various forms of twists.

In some embodiments, the twisting method may comprise the following steps. First, using tool 100 (preferably with a bristle 108′ surface feature) to smooth out any knots or tangles in the hair. Then, using at least one of tool(s) 100 (preferably tools 100 fitted to thumb, index, and middle fingers on both hands) and/or point(s) 114, separate a part of the hair desired to be twisted (a small section for smaller or thinner twists or larger sections for larger or thicker twists). Next, starting at the roots of the hair, (preferably using tool(s) 100) separate the original section into two or three sections. Then, using the both index and thumb fingers of each hand fitted with tool(s) 100, hold one of the two or three sections with each hand, then pull the hair tightly and pass one section over the other, grasping it between the index finder and middle finger of the hand with the section that has yet to be moved by the user. Still holding the hair tightly with tool(s) 100, move the second section to the other hand (and then the third section for a three-section twist) holding the second section in between the forefinger and thumb. Then, move the first section from between the middle and index fingers to between the index and thumb fingers. Lastly, pass the second section over the first section (then the third section), and then repeat the process again until the ends of the sections are reached, thereby forming a “twist.” In the final step of forming a twist, a user would secure the twist at its end away from the scalp with a band, roller, coil, clip, or other hair-affixing tool. Repeat the foregoing steps until the desired number of twists is achieved, or until the entire hair has been twisted. As a final optional step, user may seal hair using an oil or balm of user's choice, and dry the hair using a desired drying method (e.g. blow dry, air dry, and the like). Without tool 100, the twisting method could easily take over two hours to complete. However, tool 100 cuts down on this amount by 25% through 50%. An example of the results of the twisting method is shown in FIG. 9D.

In yet another embodiment, method 800 may comprise performing a hairline styling method. When performing the hairline styling method, the following tool 100 arrangement options may be used: (1) tool(s) 100 fit to index and/or middle fingers of one hand (preferably both fingers; and optionally both fingers on both hands); with preferably (but optionally) rigid point 114 on any or all (preferably at least more than one) of the foregoing tools 100; and/or wherein each tool 100 comprises one or more of the plurality of types of surface features 108 disclosed herein.

As it applies to the hairline styling method, the resistant/frictional nature of surface 106 of tool 100 serves to allow a user to grip and manipulate the hair more easily and press it against a user's scalp, and point 114 allows the user to separate the shorter and finer strands of hair (e.g. “baby hair”) more easily for styling purposes. “Hairline styling,” as used herein, means the act of using tool(s) 100 to style hair along the hairline of a head of hair, or in other words, the border of the head of hair. A sub-set of hairline styling may be referred to as “laying edges,” wherein the hair at or near the hairline or border (e.g. edge) is “laid” or pressed against a scalp in a styling manner.

In some embodiments, the hairline styling method may comprise the following steps. First, using tool 100 (preferably with a bristle 108′ surface feature) to smooth out any knots or tangles in the hair. Optionally, then using at least one of tool(s) 100 (preferably tools 100 fitted index and middle fingers on both hands) and/or point(s) 114, separate finer hairs near the edge of the hairline, and push the finer hairs using tool 100 (and preferably surface feature 108) away from the bulk of the body of hair (such as towards the face or neck), preferably starting at the roots of the finer hair. Next, dampen the finer hair using water or another moisturizing and/or hold base substance (e.g. leave-in condition, curl cream, gel, edge control paste, and the like). Next, using finger tool(s) 100 (preferably on index and middle fingers), guide and smooth the finer hair in the desired direction and/or into a desired design or shape, such as an “S” shaped swoop design, and continue along the hairline through the sideburns, or until the point where ending the hairline styling is desired. Then, use finger tool(s) 100 to ensure the hair is laid down and going in the direction preferred or maintaining the preferred design. Repeat the foregoing steps until the entire hairline is styled (or the portion of the hairline desiring to be styled). As a final optional step, user may seal hair using an oil or balm of user's choice (preferably non-touch or spray-on so as to avoid disturbing the hair shape/style via contact), and/or dry the hair using a desired drying method (e.g. blow dry, air dry, and the like). Without tool 100, the hairline styling method could easily take over half an hour to complete. However, tool 100 cuts down on this amount by 25% through 50%. An example of the results of the hairline styling method is shown in FIG. 9E.

In yet another embodiment, method 800 may comprise performing a finger detangling method. Finger detangling can be a delicate and intricate procedure. If done properly, it is preferable to go without using combs or brushes and exclusively use finger tool(s) 100. This is especially beneficial for women who have hair that easily breaks during the detangling process, which is a common downside of using combs and brushes, as has been traditionally done. Using finger tool(s) 100 may also help with length retention because the hair is at less risk of breaking when it is detangled gently using finger tool(s) 100. Some users may find that finger detangling in a dry moisturized state may be beneficial if the users hair is stronger when dry versus when wet (with water only or water/moisturizer), which can lead to the stretching of the hair and increased risk of hair breakage. Other users may find it beneficial to use water and/or a type conditioner, or the like, to provide a barrier around hair strands allowing the finger tool(s) 100 to glide or slip through the hair more easily. It is also possible to incorporate finger tool(s) 100 detangling as a first part to a detangling routine prior to using a traditional comb or brush in order to reduce the risk of hair breakage. Using the finger tool(s) 100 may save additional time, especially for certain types of hair (e.g. looser curl patterns may benefit more in time savings). For all hair styling methods disclosed herein, a user may find using the finger tool(s) 100 as an aid during this delicate process of detangling hair.

Additional benefits of using finger tool(s) 100 to detangle hair include: unlike combs and brushes, using finger tool(s) 100 provide a level of tactile sensitivity so a user is alerted before it is too late to remove a knot, or before hair breaks or is otherwise damaged. Thus, hair damage is minimized. For example, a user will be able to feel a knot, and thus pull apart the knot (such as from the root or end of the hair), which would otherwise be broken with a comb or brush. Further, detangling hair using finger tool(s) provides additional benefits: saving time in wash and conditioning process; provides for restyling without washing; follow detangling with finger tool(s) 100 with a comb for looser curls, or the ability to skip this step if needed; easier detangling in the shower; and/or the ability to skip final rake through with comb for final check with finger tool.

When performing the finger detangling method, while other arrangements are possible, the following tool 100 arrangement is preferred: equipping thumb, index, and middle fingers each with a tool 100 (preferably point 114 on index finger's tool 100); and/or wherein each tool 100 comprises one or more of the plurality of types of surface features 108 disclosed herein, based on a user's preference.

In some embodiments, the finger detangling method may comprise the following steps. First, using tool 100 (preferably with a point 114), section hair into a plurality of sections (preferably four or more), and clip or secure away all sections but one. Optionally, next, dampen the hair using water or another moisturizing substance (e.g. conditioner, oil, or the like, as desired). Optionally, based on user preference, start on dry hair to maintain hair that has been stretched such as by having used rollers or other hair straightening tools or methods. Further, take the remaining section that has not been secure, and separate into smaller subsections, taking all but one of the smaller subsections and securing them.

Next, on the remaining section (or sub-section) of hair, gently run finger tool(s) 100 through the hair in a preferred direction (end to root or root to end) to remove tangles and shedding hair. Repeat moving finger tool(s) 100 through hair until the section is detangled. Once the section is detangled as desired, then twist, braid or style hair as desired, including according to any of the methods disclosed herein (e.g. MCT method, coiling, and the like) (if desired at all).

When de-tangling and/or styling complete of the subsection of hair is complete, secure away the completed subsection of hair. Part or section a new section subsection of hair (preferably using point 114), and repeat the foregoing steps on that section or subsection until completion.

Repeat the foregoing steps until the entire hair (or portion thereof) is detangled and/or styled. As a final optional step, user may seal hair using an oil or balm of user's choice (preferably non-touch or spray-on so as to avoid disturbing the hair shape/style via contact), and/or dry the hair using a desired drying method (e.g. blow dry, air dry, and the like). Without tool 100, traditional detangling methods using combs and/or brushes could easily take over two hours to complete. However, tool 100 cuts down on this amount by 25% through 50%.

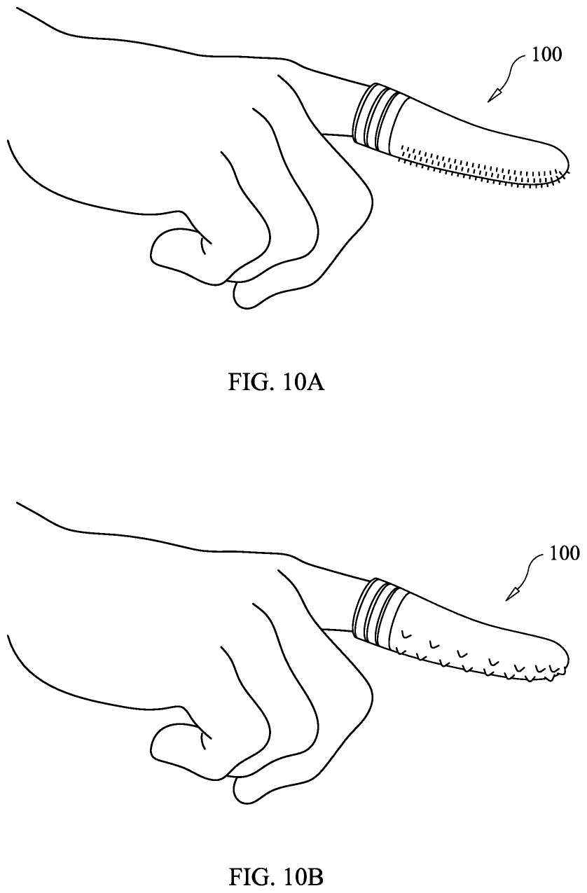

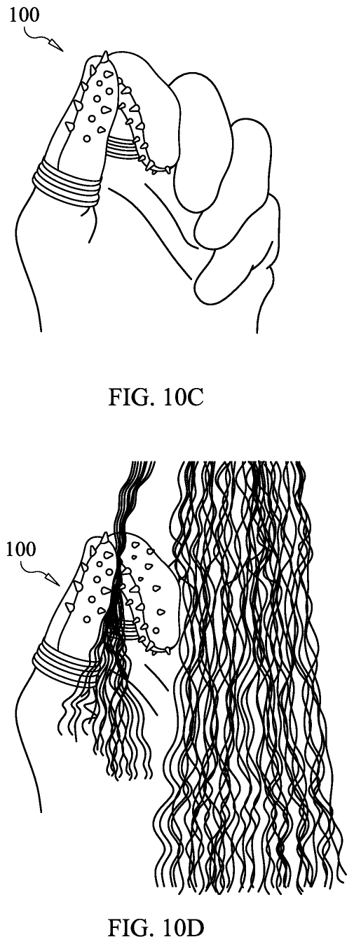

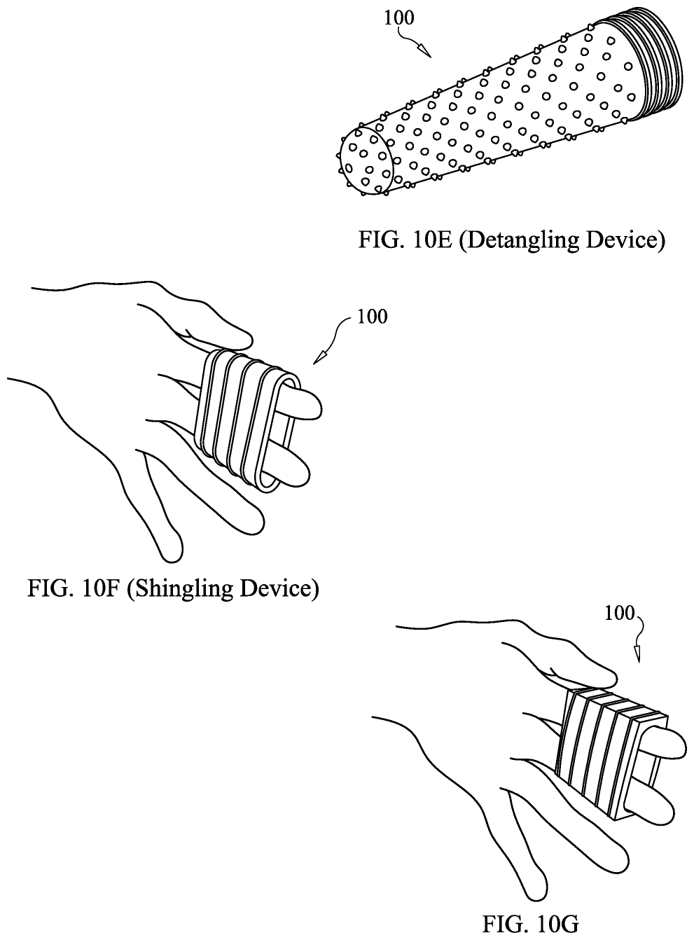

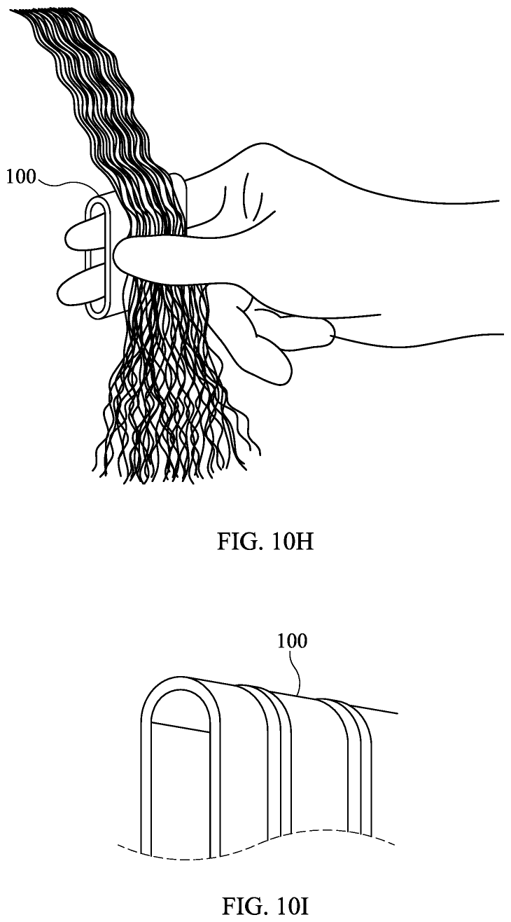

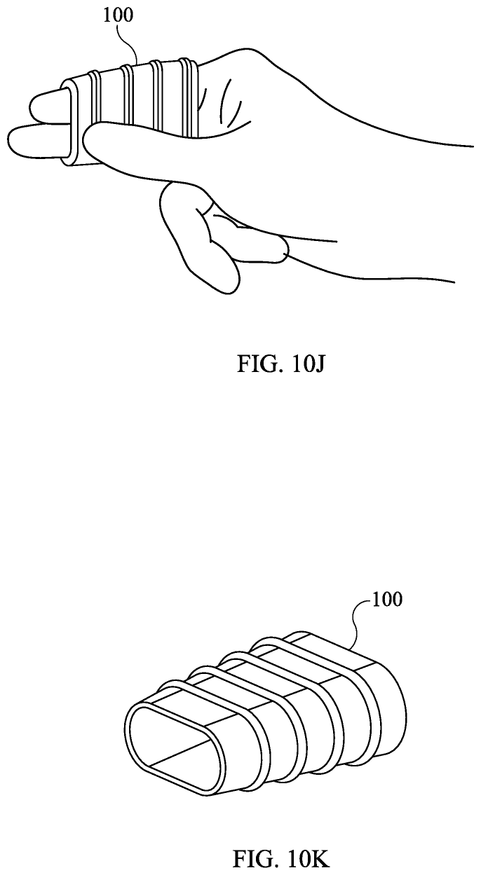

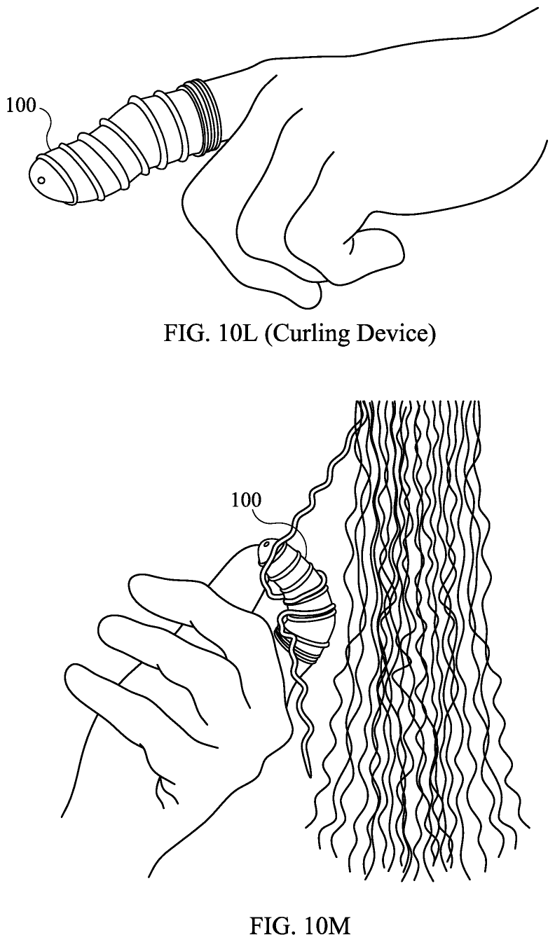

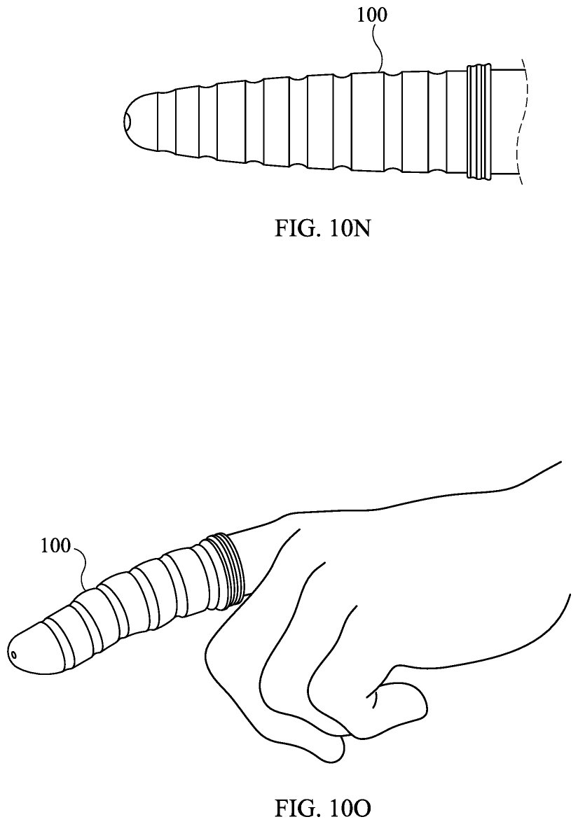

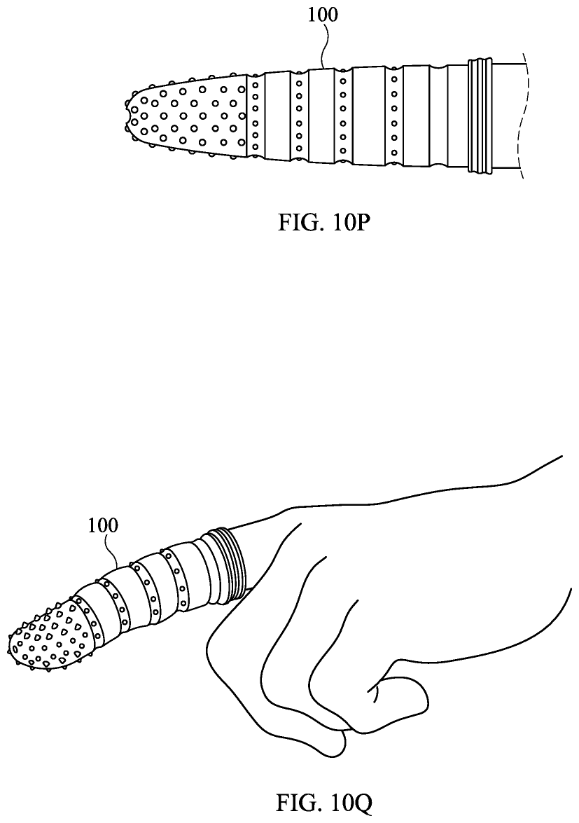

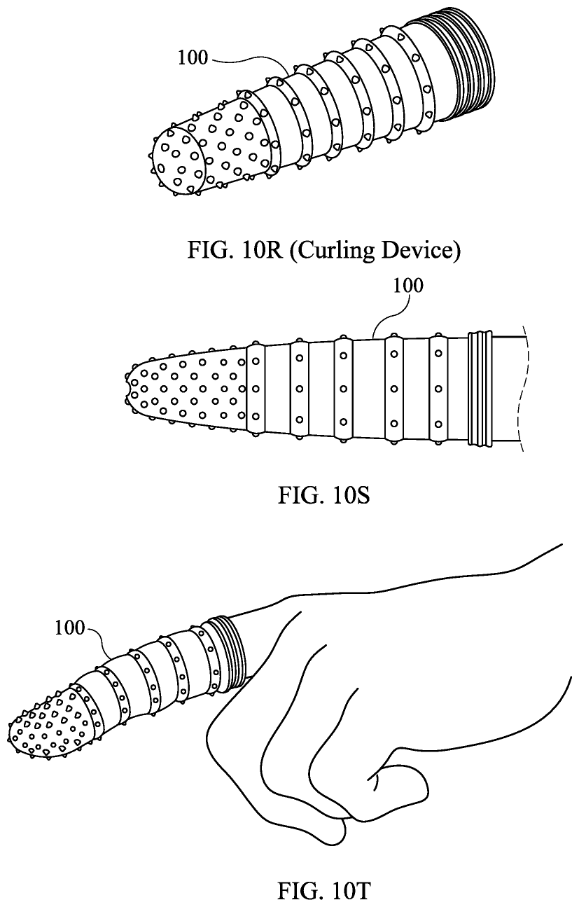

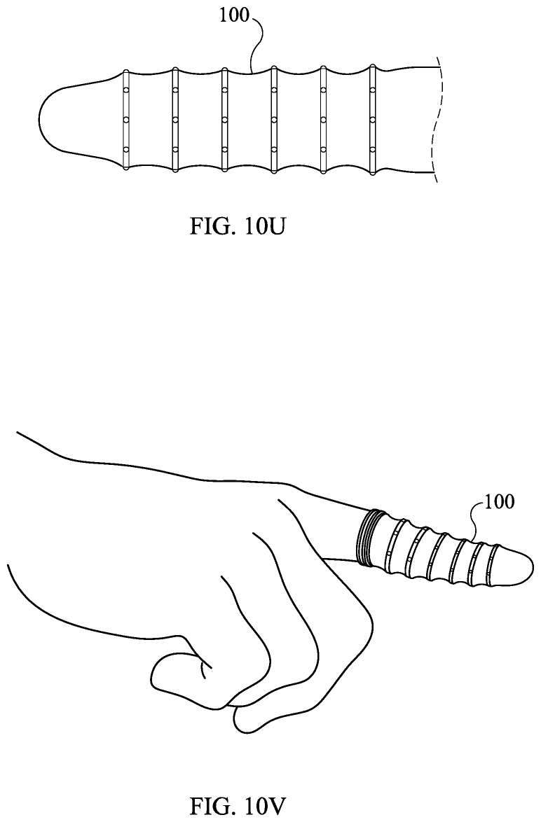

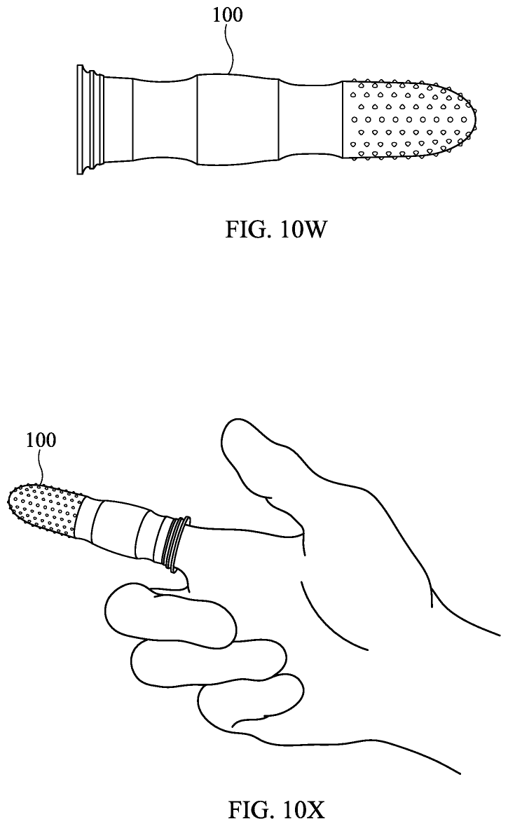

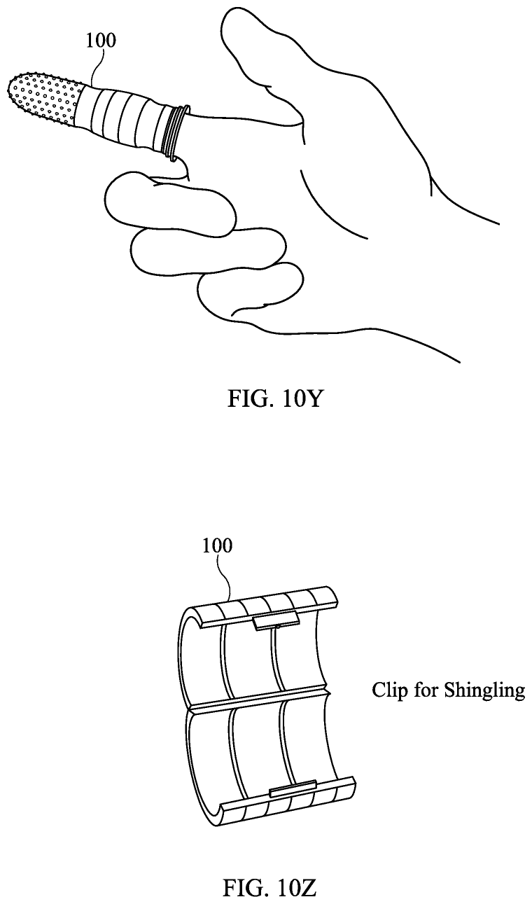

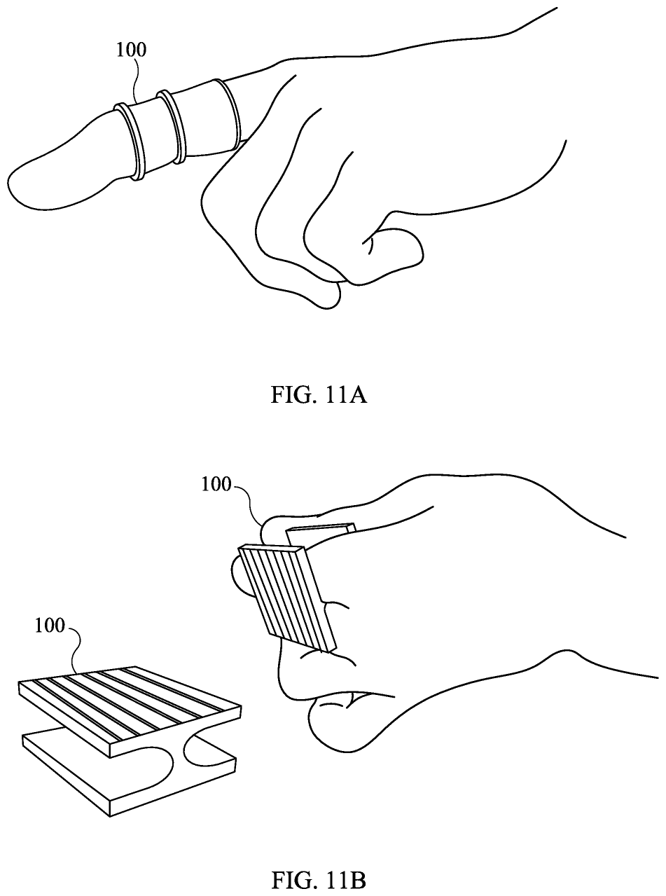

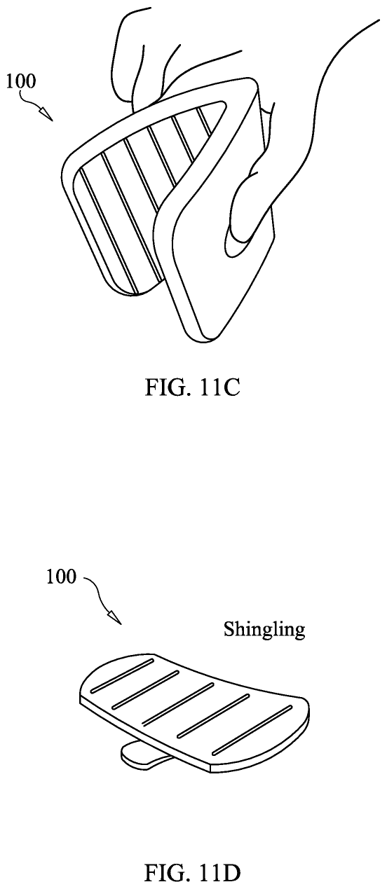

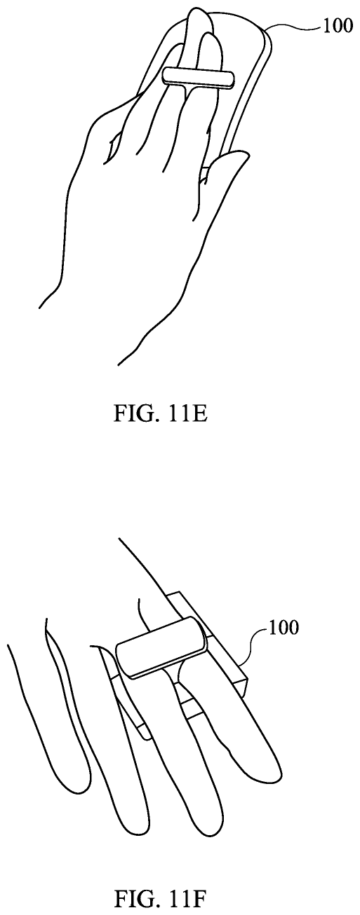

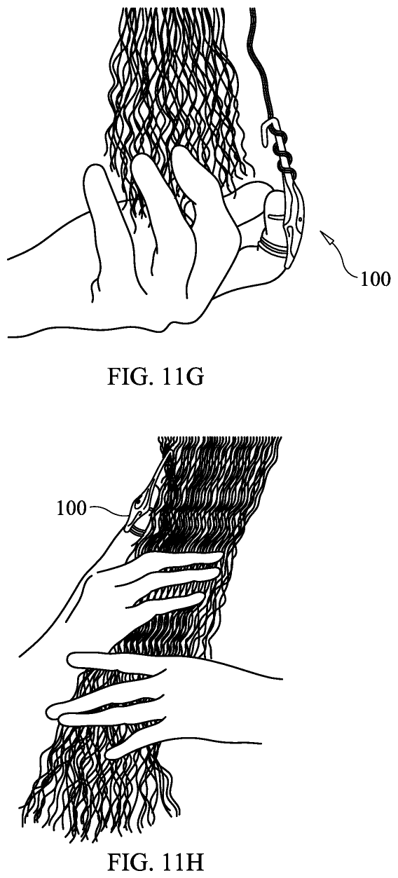

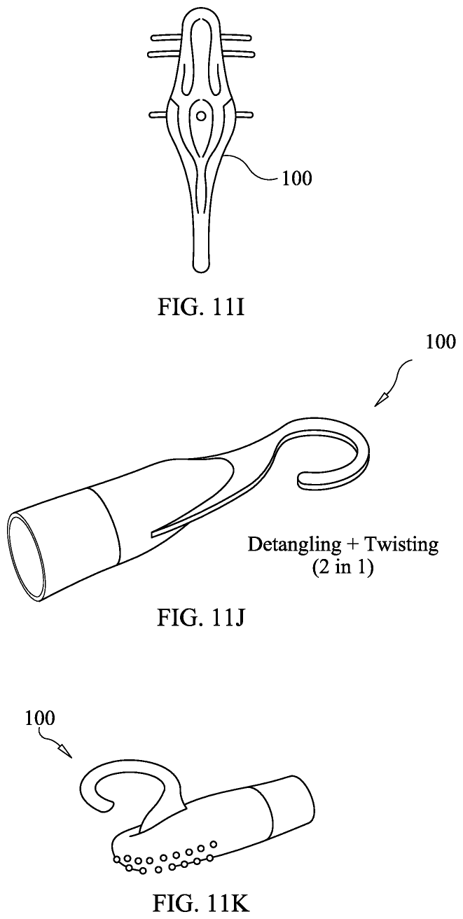

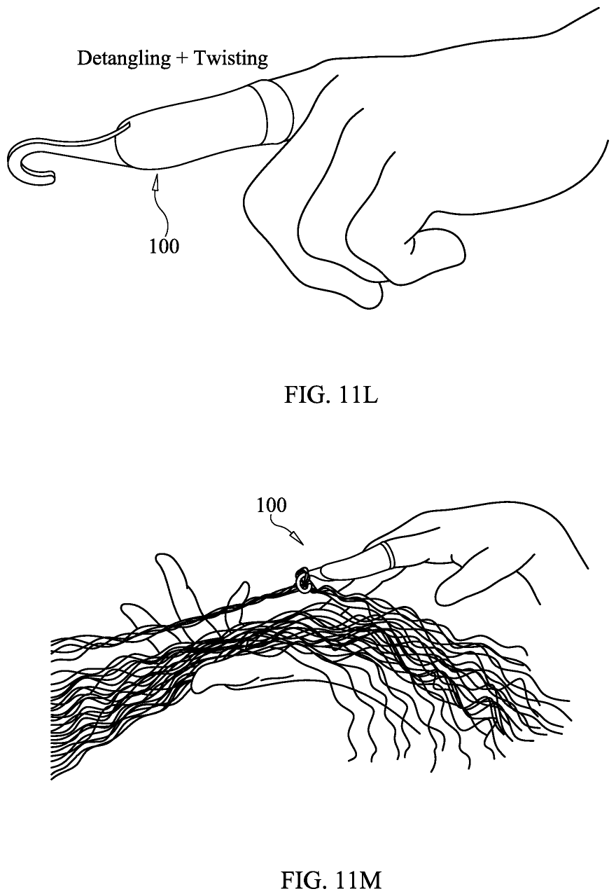

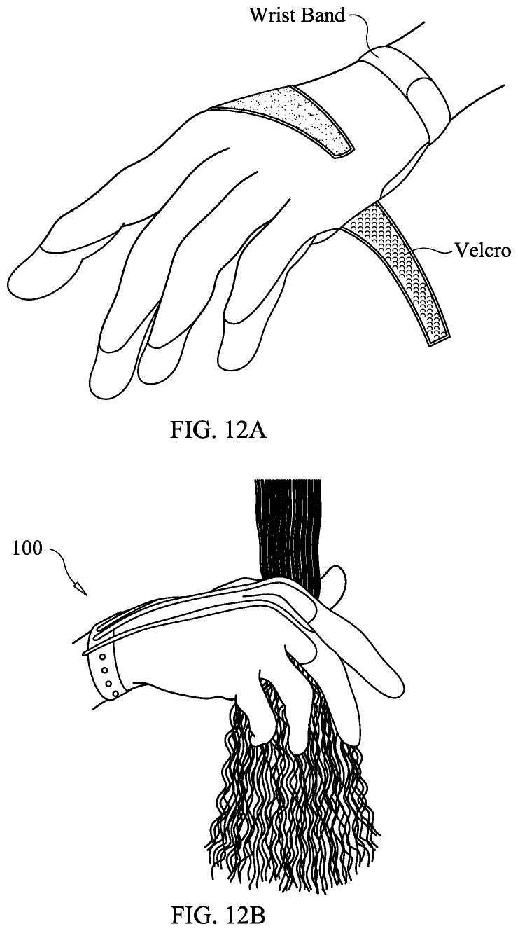

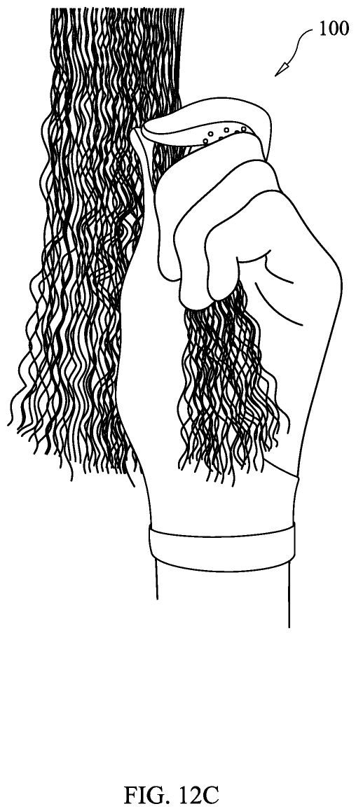

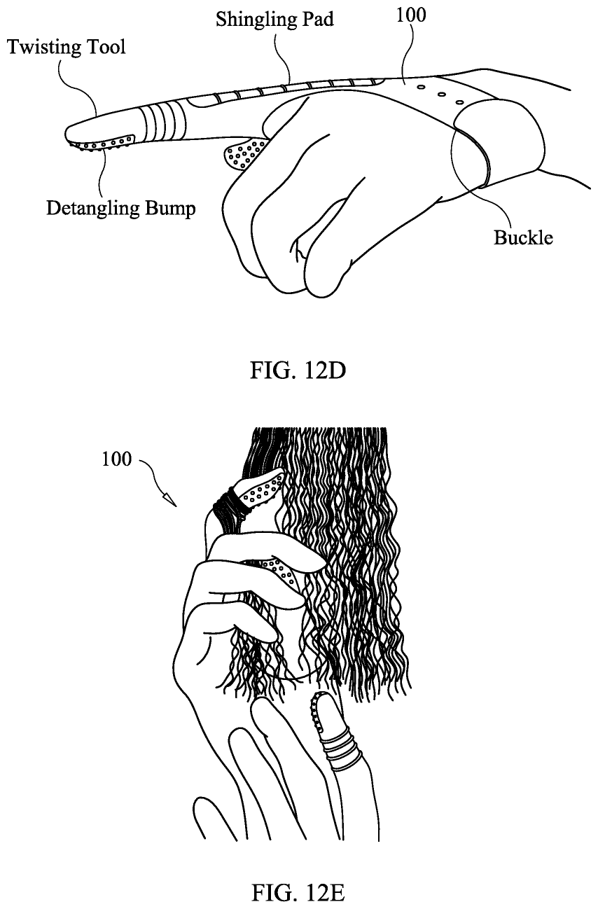

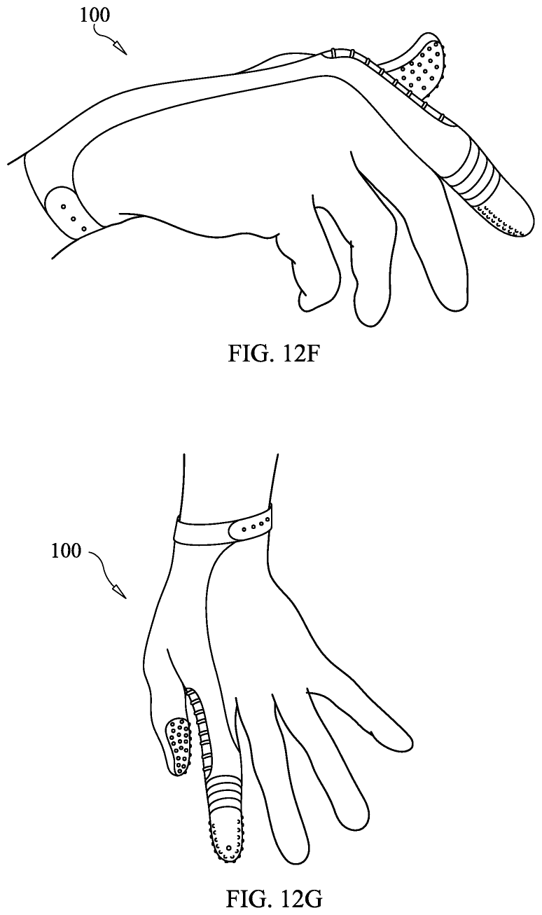

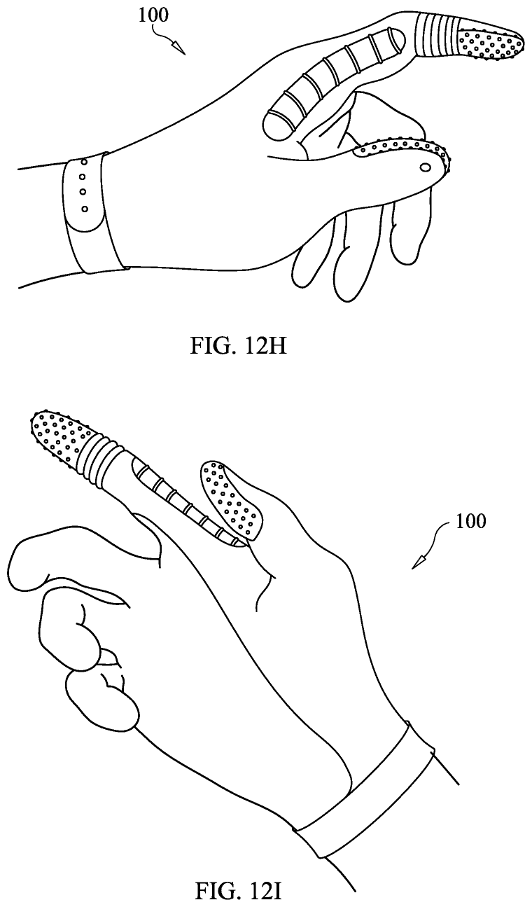

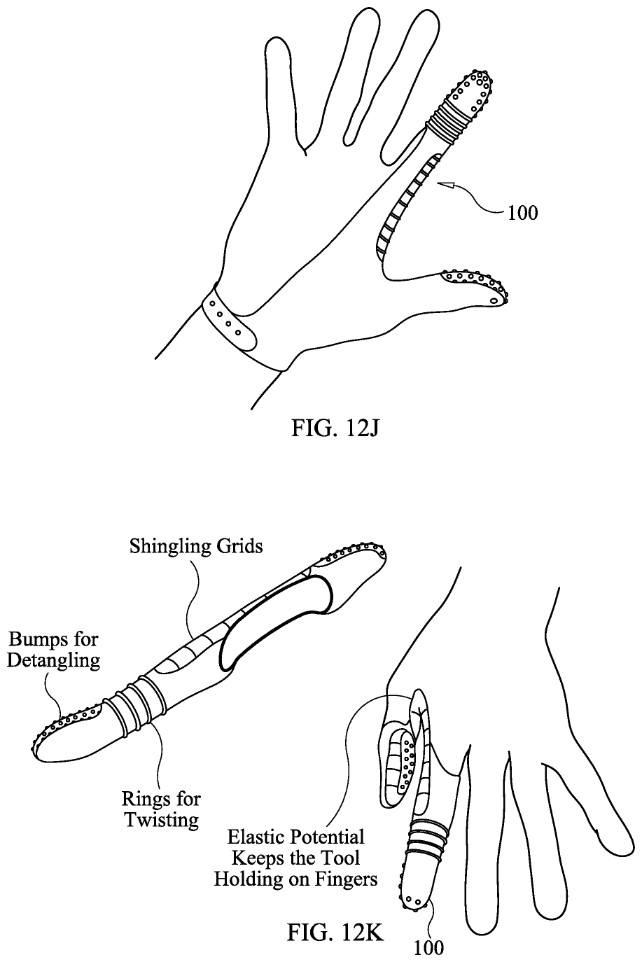

FIGS. 10A-12K show hair styling tools in accordance with various embodiments, some of which feature single-finger embodiments, others feature multi-finger embodiments, and yet others feature leashes, wrist wraps, and/or buckles to further secure the tool to a user's body. While certain features of this invention have been shown, described and/or claimed, it is not intended to be limited to the details above, since it will be understood that various omissions, modifications, substitutions and changes in the apparatuses, forms, method, steps and system illustrated and in its operation can be made by those skilled in the art without departing in any way from the spirit of the present invention.

What is claimed is:

1. A hair styling finger tool comprising:
a flexible body formed in the shape of a human finger, wherein the body comprises a surface; and
a plurality of hair guiding features disposed on the surface of the body.

2. The tool of claim 1, wherein the plurality of hair guiding features comprises a plurality of studs.

3. The tool of claim 1, wherein the plurality of hair guiding features comprises a plurality of bristles.

4. The tool of claim 1, wherein the plurality of hair guiding features comprises a plurality of grooves.

5. The tool of claim 4, wherein each of the plurality of grooves are parallel to each other.

6. The tool of claim 1, wherein the plurality of features comprises one or more grooves formed in a spiral or corkscrew extending along a length of the body.

7. The tool of claim 1, wherein the body is formed of rubber or another substance having a dynamic surface-to-hair coefficient of friction in the range of 0.15 through 0.75.

8. The tool of claim 1, wherein the body is a unitary body.

9. The tool of claim 8, wherein the unitary body and plurality of hair guiding features are formed of rubber or another substance having a dynamic surface-to-hair coefficient of friction in the range of 0.15 through 0.75.

10. The tool of claim 1, wherein the body comprises an open end configured to receive a finger, and a closed end, wherein the closed end comprises a rigid point or a uniformly rounded end.

11. The tool of claim 10, wherein the rigid point is a hair separator.

12. The tool of claim 1, wherein the plurality of features are distributed evenly over the surface of the body.

13. A method of styling hair, comprising:
providing a hair styling finger tool for use on a finger, wherein the hair styling finger tool comprises:
a flexible body formed in the shape of a human finger, wherein the body comprises a surface, and
a plurality of hair guiding features disposed on the surface of the body; and
using the hair styling finger tool to perform a hair styling method with a finger.

14. The method of claim 13, wherein the hair styling method comprises multistrand clustered texturing.

15. The method of claim 13, wherein the hair styling method comprises coiling.

16. The method of claim 13, wherein the hair styling method comprises hairline styling or detangling.

17. The method of claim 13, wherein the hair styling method comprises braiding.

18. The method of claim 13, wherein the hair styling method comprises twisting.

19. A hair styling finger tool kit comprising:
a plurality of hair styling finger tools, wherein each of the plurality of hair styling finger tools comprises a flexible body formed in the shape of a human finger, wherein the body comprises a surface, and a plurality of hair guiding features disposed on the surface of the body;
wherein the hair guiding features on a first of the plurality of hair styling finger tools comprises a plurality of studs;
wherein the hair guiding features on a second of the plurality of hair styling finger tools comprises a plurality of bristles;
wherein the hair guiding features on a third of the plurality of hair styling finger tools comprises a plurality of grooves; and
at least one of the plurality of hair styling finger tools comprises an open end and a closed end, wherein the closed end comprises a rigid point or a uniformly rounded end.

20. The hair styling finger tool kit of claim 19, further comprising a set of instructions for how to use at least one of the plurality of hair styling finger tools to style hair.
